(19) United States
(12) Patent Application Publication
(10) Pub. No.: US 2025/0190173 A1
(43) Pub. Date: Jun. 12, 2025

(54) NON-LINEAR FUNCTION COMPUTING APPARATUS AND NON-LINEAR FUNCTION COMPUTING METHOD

(71) Applicant: ELECTRONICS AND TELECOMMUNICATIONS RESEARCH INSTITUTE, Daejeon (KR)

(72) Inventors: Jin Kyu KIM, Daejeon (KR); Jin Ho HAN, Daejeon (KR)

(73) Assignee: ELECTRONICS AND TELECOMMUNICATIONS RESEARCH INSTITUTE, Daejeon (KR)

(21) Appl. No.: 18/975,835

(22) Filed: Dec. 10, 2024

(30) Foreign Application Priority Data
Dec. 11, 2023 (KR) 10-2023-0178791
Nov. 25, 2024 (KR) 10-2024-0169453

(51) Int. Cl. G06F 7/544; G06F 7/498

(52) U.S. Cl. CPC G06F 7/544; G06F 7/4981; G06F 7/4983

(57) ABSTRACT

The present embodiment relates to a computing apparatus for computing an interpolated non-linear activation function for an input. The computing apparatus includes a plurality of unit processing elements (PEs), and each unit PE includes: a multiplier that multiplies the input and an output of an accumulator, an adder that adds the output of the multiplier and a coefficient of the interpolated non-linear activation function; and an accumulator that accumulates and outputs the output of the adder.

### CROSS-REFERENCE TO RELATED APPLICATION

This application claims priority to and the benefit of Korean Patent Applications No. 10-2023-0178791, filed on Dec. 11, 2023, and No. 10-2024-0169453, filed on Nov. 25, 2024, the disclosure of which is incorporated herein by reference in its entirety.

### BACKGROUND

### 1. Field of the Invention

The present invention generally relates to a non-linear function computing apparatus and a non-linear function computing method.

### 2. Discussion of Related Art

Artificial intelligence technology is trending towards transformer-based language intelligence, evolving from the visual intelligence field led by a convolutional neural network (CNN). Since these neural networks require large amounts of hardware computation, they inevitably use devices with high data computation processing rates, such as a graphics processing unit (GPU) server.

Looking at the types of computation, matrix multiplication and addition account for the largest amount of computation in not only a CNN but also a transformer-based artificial neural network, but the proportion of non-linear functions used in activation functions, etc., cannot be considered insignificant. Generally, it is known that CNNs account for about 10% and transformer series neural networks account for about 20%.

As the non-linear functions mainly used in language intelligence neural networks, there are softmax and a Gaussian error linear unit (GELU), which are mainly used in transformer series such as bidirectional encoder representations from transformers (BERT) and generative pre-trained transformer 3 (GPT-3).

The GELU function has recently been used in large language models (LLMs) such as GPT-3 and large language model meta AI-1/2 (LLaMA-1/2). The GELU function was originally designed to use a sigmoid function and an error function and is a mathematically approximated form. The GELU function is used for a fast computation when a fast GELU computation is required on a central processing unit (CPU) or GPU.

### SUMMARY OF THE INVENTION

The present invention is directed to providing a method of accelerating a computation speed while lowering hardware cost by providing a means for accelerating an operation of an activation function used in an artificial neural network computation and presenting a hardware structure and a specific computation flow related thereto.

According to an aspect of the present invention, there is provided a computing apparatus for computing an interpolated nonlinear activation function for an input including a plurality of unit processing elements (PEs), in which each of the unit PEs includes: a multiplier that multiplies the input and an output of an accumulator; an adder that adds the output of the multiplier and a coefficient of the interpolated nonlinear activation function; and an accumulator that accumulates and outputs the output of the adder.

After the computation is completed, the output of the accumulator may correspond to a result of calculating the interpolated non-linear activation function for the input.

Each of the unit PEs may further include: a coefficient memory that stores the coefficient of the interpolated non-linear activation function; and a pre-processor that controls the coefficient memory to output the coefficient stored in the coefficient memory.

Each of the unit PEs may further include: a post-processor that, when a final computation result of the interpolated non-linear activation function for the input is accumulated in the accumulator, controls the computation result from the accumulator to be output to the outside.

The non-linear activation function may be one of a rectified linear unit (ReLU) function, a Gaussian error linear unit (GeLu), and a sigmoid function.

The interpolated non-linear activation function may be a non-linear activation function interpolated with a quadratic function.

The computing apparatus may sequentially perform a plurality of operations, and a first operation among the plurality of operations may be performed by multiplying, by the multiplier, an output of an initialized accumulator and the input, and outputting a result of adding, by the adder, the multiplied result and a coefficient of a highest order term of the non-linear activation function to the accumulator.

An operation after the first operation among the plurality of operations may be performed by storing, by the accumulator, the added result from the adder and outputting the stored added result to the multiplier, multiplying, by the multiplier, an output of the accumulator and the input, and outputting a result of adding, by the adder, the multiplied result and the coefficient of the non-linear activation function to the accumulator.

A last operation among the plurality of operations may be performed by: storing, by the accumulator, the added result from the adder and outputting the stored added result to the post-processor, and outputting, by the post-processor, the computation result from the accumulator.

The computing apparatus may perform a pipeline computation with the plurality of unit PEs to perform the plurality of operations on the pipeline computation sequentially

According to another aspect of the present invention, there is provided a computing method of computing an interpolated non-linear activation function for an input with a computing apparatus including a plurality of unit processing elements (PEs), wherein the computing method includes a plurality of phases performed sequentially, each of which includes an operation of multiplying, by a multiplier, an output of an accumulator and the input, and an operation of outputting a result of adding, by an adder, the multiplied result from the multiplier and a coefficient of the non-linear activation function to the accumulator.

A first phase may include: an operation of multiplying, by the multiplier, an output of an initialized accumulator and the input; and an operation of outputting a result of adding, by the adder, the multiplied result from the multiplier and the coefficient of the non-linear activation function to the accumulator.

An operation after the first operation among the plurality of operations performed sequentially may be performed by: storing and outputting, by the accumulator, the added result from the adder, multiplying, by the multiplier, the output of the accumulator and the input, and outputting a result of adding, by the adder, the multiplied result and the coefficient of the non-linear activation function to the accumulator.

A last operation among the plurality of operations may be performed by storing, by the accumulator, the added result from the adder and outputting the stored added result to the post-processor, and outputting, by the post processor, the computation result from the accumulator.

The plurality of sequentially performed operations may be performed in a pipeline manner in the plurality of unit PEs.

The interpolated non-linear activation function may be a non-linear activation function interpolated with a quadratic function.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a diagram schematically illustrating a computing apparatus of the present invention;

FIG. 2 is a diagram schematically illustrating a unit processing element (PE) of the present embodiment;

FIG. 3 is a flowchart schematically illustrating a non-linear function acceleration computing method of the present embodiment;

FIG. 4 is a diagram for describing an interpolation method of a non-linear activation function;

FIG. 5 is a diagram schematically illustrating the unit PE for describing a first phase of a computing method of computing an interpolated non-linear activation function for an input;

FIG. 6 is a diagram schematically illustrating a unit PE for describing a second phase of a computing method of computing an interpolated non-linear activation function for an input;

FIG. 7 is a diagram schematically illustrating a unit PE for describing a third phase of the computing method of computing the interpolated non-linear activation function for an input; and

FIG. 8 is a diagram schematically illustrating a unit PE for describing a fourth phase of the computing method of computing the interpolated non-linear activation function for an input.

### DETAILED DESCRIPTION OF EXEMPLARY EMBODIMENTS

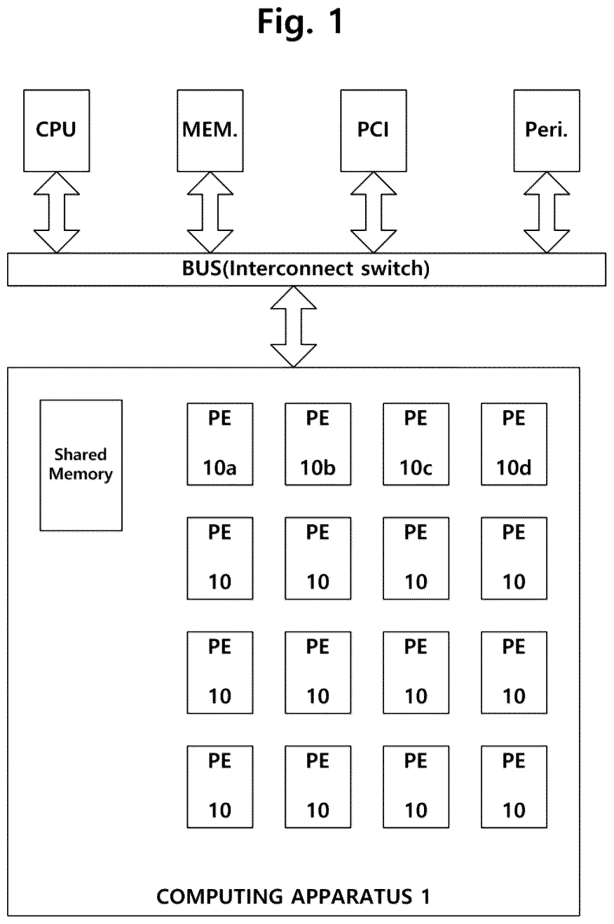

Hereinafter, the present embodiment will be described with reference to the accompanying drawings. FIG. 1 is a diagram schematically illustrating a computing apparatus 1 of the present invention. Referring to FIG. 1, the computing apparatus 1 of the present embodiment includes a shared memory and a plurality of unit processing elements (PEs) 10. In an embodiment, the computing apparatus 1 may be a multiply and accumulate (MAC) array core that performs MAC of a matrix in an artificial neural network computation, and may perform a non-linear function acceleration computation of the present embodiment using the MAC array core.

The computing apparatus 1 may be connected to a central processing unit (CPU), a memory (MEM.), a peripheral component interconnect (PCI), and/or a peripheral device (Peri) via a bus. The bus may be, for example, one of an on-chip bus and a system bus.

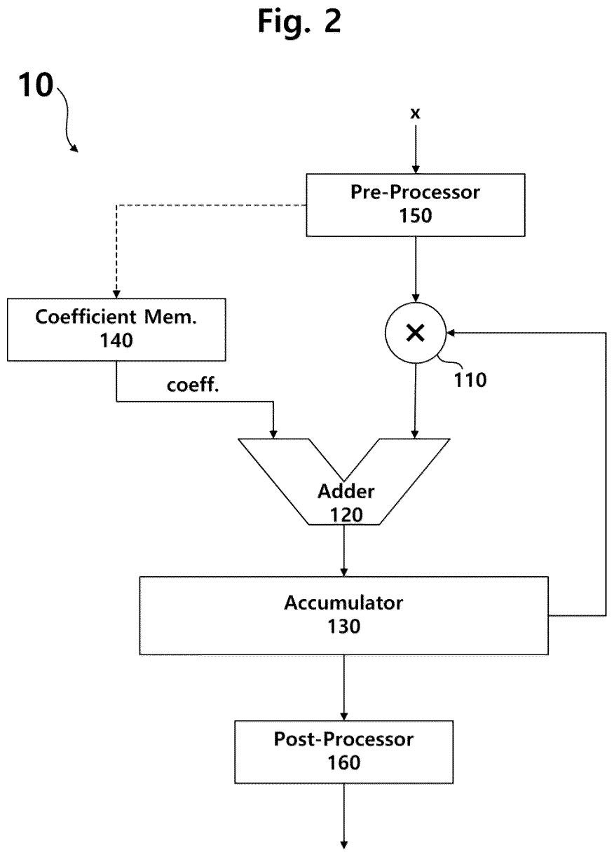

FIG. 2 is a diagram schematically illustrating the unit PE of the present embodiment. Referring to FIG. 2, the unit PE 10 includes a multiplier 110 that multiplies an input x and an output of an accumulator 130, an adder 120 that adds an output of the multiplier 110 and a coefficient (coeff.) of an interpolated non-linear activation function output by a coefficient memory 140 that stores a coefficient of an interpolated non-linear activation function, and the accumulator 130 that accumulates and outputs the output of the adder 120.

In an embodiment, the unit PE 10 may further include a pre-processor 150 that provides the provided input x to the multiplier 110 and controls the coefficient memory 140 to output the coefficient of the interpolated non-linear activation function corresponding to the operation of the computation, and a post-processor 160 that outputs the result of the accumulated computation by the accumulator 130 according to the operation of the computation.

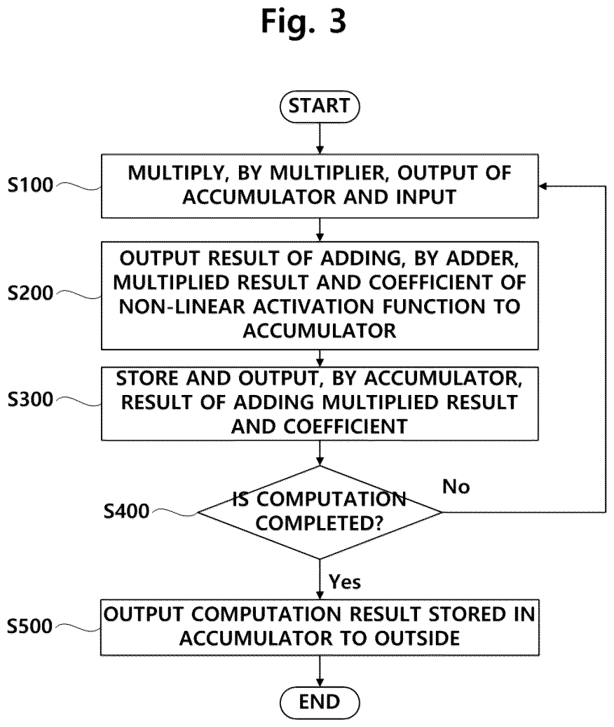

FIG. 3 is a flowchart schematically illustrating a non-linear function acceleration computing method of the present embodiment. Referring to FIG. 3, the non-linear function acceleration computing method of the present embodiment includes a plurality of phases that are sequentially performed, and each of the phases includes: an operation (S100) of multiplying, by the multiplier 110, the output of the accumulator 130 and the input x, and an operation (S200) of outputting a result of adding, by the adder 120, the multiplied result of the multiplier 110 and the coefficient (coeff.) of the non-linear activation function to the accumulator 130.

In an embodiment, in some phases, the computing method may include an operation (S300) of storing and outputting, by the accumulator 130, the result of adding the input multiplied result and the coefficient (coeff.). In addition, in an embodiment, the computing method may further include an operation (S400) of identifying whether the computation of the interpolated nonlinear activation function for the input x is completed. When it is determined in the identifying operation (S400) that the computation is not completed, the next phase is performed (S100), but when the computation is completed, the post-processor 160 outputs the computation result stored in the accumulator (S500).

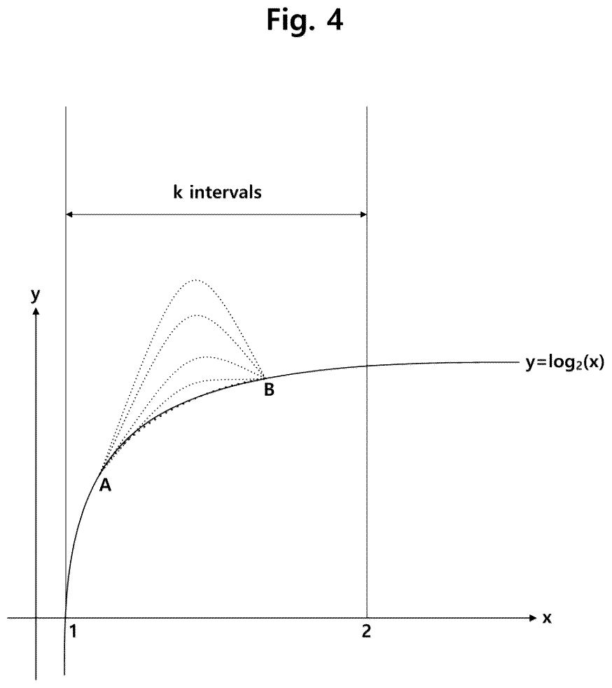

FIG. 4 is a diagram for describing an interpolation method of a non-linear activation function. The non-linear activation function exemplified in FIG. 4 is log₂ (x), and FIG. 4 schematically presents a method of interpolating the non-linear activation function with a quadratic function. The following equation is an equation for describing the quadratic function interpolation method, which finds a quadratic function closest to the non-linear function log₂ (x) function in an interval between two points A and B.

$${log}_{2} ( x ) ≅ \frac{p ( x )}{q ( x )} = \frac{{p}_{n} {x}^{n} + {p}_{n - 1} {x}^{n - 1} + ⋯ + {p}_{1} x + {p}_{0}}{{q}_{n} {x}^{n} + {q}_{n - 1} {x}^{n - 1} + ⋯ + {q}_{1} x + {q}_{0}} = {c}_{x} {x}^{2} + {c}_{1} x + {c}_{0} \qquad [ Equation 1 ]$$

Approximation is performed by obtaining coefficients c₂, c₁, and c₀, which minimize an error area, stepwise. As the number of total intervals increases, a width of a single interval decreases, so the approximation accuracy increases. However, since the number of coefficients stored and used in memory increases in proportion to the number of intervals, the memory size increases. The illustrated diagram illustrates a method of approximating and interpolating by subdividing a value between 1 and 2 into k intervals in the approximation process of log₂ (x) (k: positive integer). The coefficients c₂, c₁, and c₀ obtained by the computation may be stored in the coefficient memory 140 of each unit PE 10, and output to the adder 120 according to an address provided by the pre-processor 150.

The illustrated embodiment exemplifies a method of interpolating the non-linear function log₂(x) with the quadratic function, but this is only an example, and non-linear functions, such as an exponential function of e^{(x)}, a trigonometric function such as sin(x), and a hyperbolic trigonometric function such as tanh(x) which are a non-linear function, may be interpolated. In addition, the non-linear activation function is one of a rectified linear unit (ReLU) function, a Gaussian error linear unit (GeLu), and sigmoid function.

Furthermore, the interpolation may be performed with a polynomial of degree 3 or higher to obtain the non-linear activation function with higher accuracy, or the interpolation may be performed with a linear function to obtain the non-linear activation function with faster computation speed

Hereinafter, the computing method for computing an interpolated non-linear activation function for the operation and input of the unit PE 10 of the present embodiment will be described with reference to FIGS. 3, 5, and 8. However, this is for a more concise and clear description, and a person skilled in the art will be able to easily understand a method of computing an interpolation function of degree 3 or higher for an input and/or a method of computing a function interpolated with a first-order function by referring to the description below.

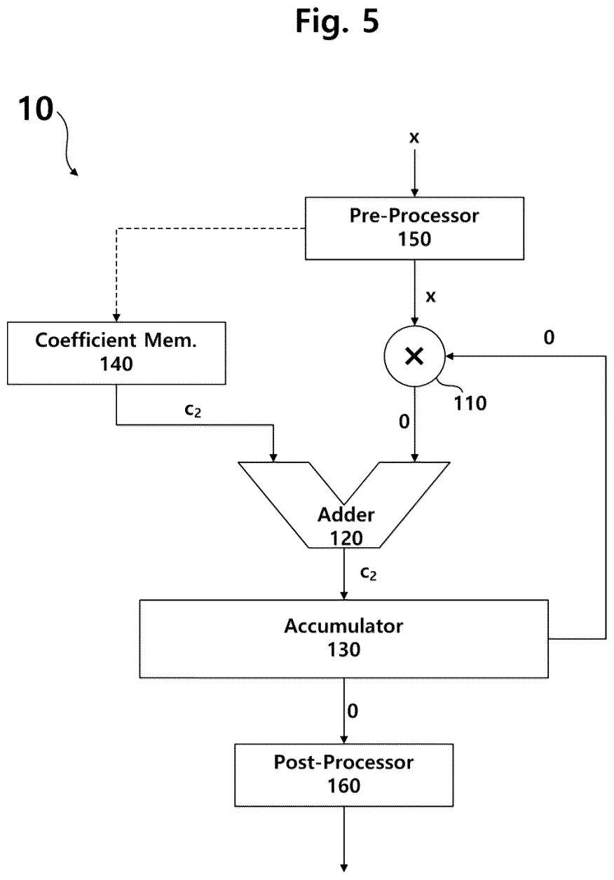

FIG. 5 is a diagram schematically illustrating the unit PE for describing a first phase of the computing method of computing an interpolated non-linear activation function for an input. Referring to FIGS. 3 and 5, the pre-processor 150 outputs the provided input x to the multiplier 110, and provides an address of the coefficient memory 140, in which a second-order term coefficient c₂ of the interpolated second-order function is stored, to the coefficient memory 140. The coefficient memory 140 outputs the second-order term coefficient c₂ stored in the provided address to the adder 120.

As described above, the input x is provided to one input of the multiplier 110, and the output of the accumulator 130 is provided to the other input. In the first phase, the accumulator 130 is initialized to 0, and the accumulator 130 outputs the initialized value to the multiplier 110. Therefore, the multiplier 110 outputs 0, which is the result of multiplying the input x and 0, to the adder 120 (S100). The adder 120 outputs c₂, which is the result of adding 0 output by the multiplier and the coefficient c₂ of the second term output by the coefficient memory 150, to the accumulator 120 (S200).

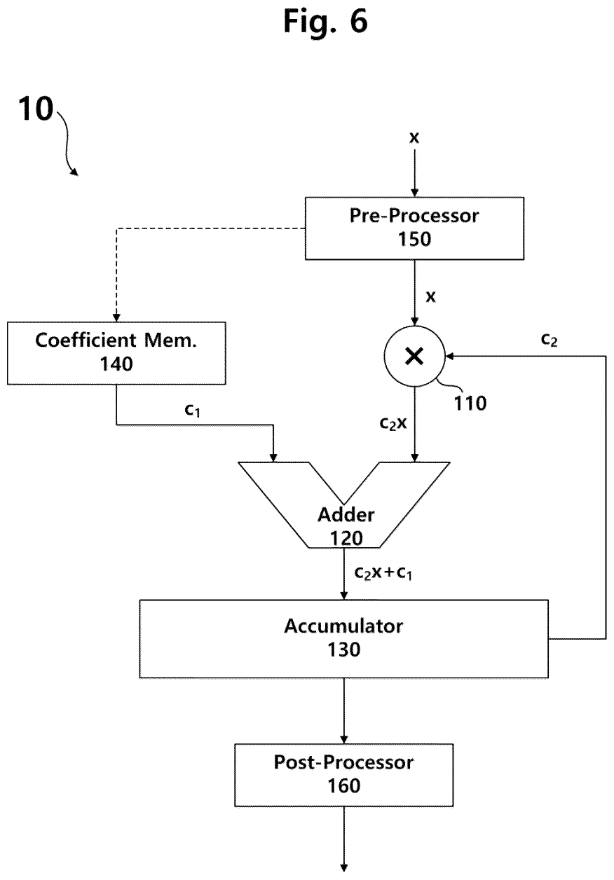

FIG. 6 is a diagram schematically illustrating a unit PE for describing a second phase of the computing method of computing an interpolated non-linear activation function for an input. Referring to FIGS. 3 and 6, in the second phase, the accumulator 130 accumulates and stores the initialization value 0 and the coefficient c₂ of the quadratic term, and the accumulator 130 outputs the accumulated and stored c₂ to the multiplier 110 (S300).

The post-processor 160 determines whether the result c₂ output by the accumulator 130 is the completed computation result (S400). Since the computation is not completed, the post-processor 160 does not output the computed result to the outside.

The pre-processor 150 outputs the provided input x to the multiplier 110. In an embodiment, the pre-processor 150 may sample the input x input in the first phase and output the sampled value in a subsequent phase.

The multiplier 110 multiplies c₂ output by the accumulator 130 and the input x (S100), and outputs the multiplied result c₂x to the adder 120.

The pre-processor 150 provides the address of the coefficient memory 140, in which the coefficient c₁ of the first term of the interpolated second-order function is stored, to the coefficient memory 140. The coefficient memory 140 outputs the first-order term coefficient c₁ stored in the provided address to the adder 120. The adder 120 outputs c₂x+c₁, which is the result of adding c₂x output by the multiplier and the coefficient c₁ of the first-order term output by the coefficient memory 150, to the accumulator 130 (S200). In an embodiment in which the interpolation is performed with the function of degree 3 or higher, the second phase may be performed until the coefficient memory 140 outputs a value of a constant term.

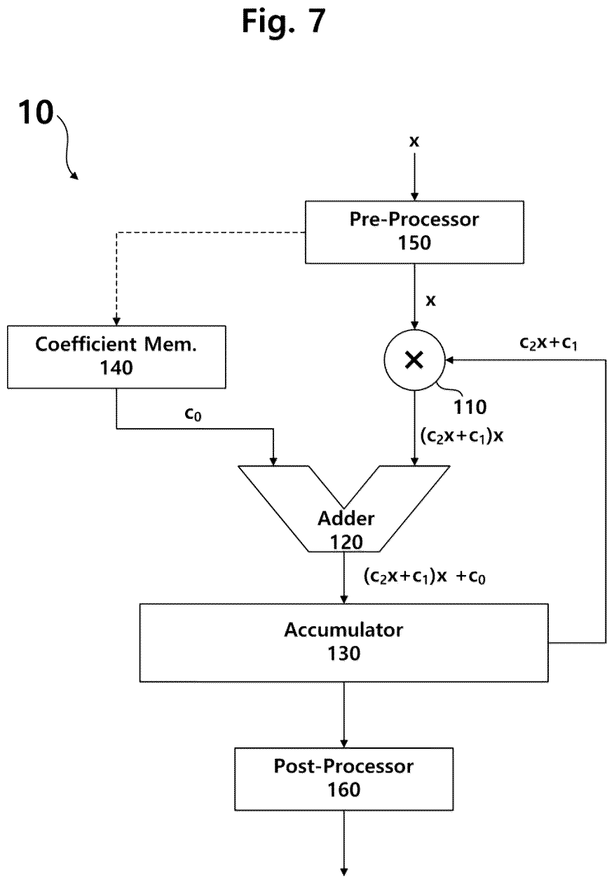

FIG. 7 is a diagram schematically illustrating the unit PE 10 for describing a third phase of the computing method of computing an interpolated non-linear activation function for an input. Referring to FIGS. 3 and 7, in the third phase, c₂x+c₁ is stored in the accumulator 130 (S300), and the accumulator 130 outputs c₂x+c₁ to the multiplier 110.

The post-processor 160 determines whether the result output by the accumulator 130 is the completed computation result (S400). Since the computation is not completed, the post-processor 160 does not output the computed result to the outside.

The pre-processor 150 outputs the provided input x to the multiplier 110. The multiplier 110 multiplies c₂x+c₁ output by the accumulator 130 and the input x, and outputs the multiplied result (c₂x+c₁)x to the adder 120 (S100).

The pre-processor 150 provides the address of the coefficient memory 140, in which the constant term c₀ of the interpolated second-order function is stored, to the coefficient memory 140. The coefficient memory 140 outputs the constant term c₀ stored in the provided address to the adder 120. The adder 120 adds (c₂x+c₁)x output by the multiplier and the coefficient c₀ of the constant term output by the coefficient memory 150, and outputs the added result (c₂x+c₁)x+c to the accumulator 130 (S200).

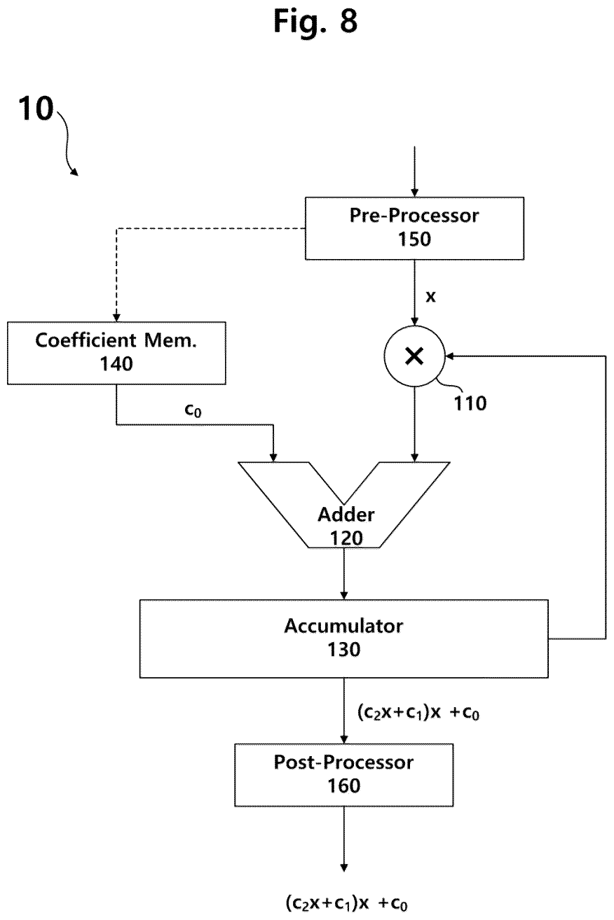

FIG. 8 is a diagram schematically illustrating the unit PE 10 for describing a fourth phase of the computing method of computing an interpolated non-linear activation function for an input. Referring to FIGS. 3 and 8, in the fourth phase, the accumulator 130 stores the computation result (c₂x+c₁)x+c₀ output by the adder 120, and outputs (c₂x+c₁)x+c₀ to the post-processor 160 (S300).

The post-processor 160 determines that the computation is completed (S400). Since the computation is completed, the post-processor 160 outputs the computation result (c₂x+c₁)x+c₀ output by the accumulator 130 to the outside (S500). In addition, the post-processor 160 may initialize the accumulated value in the accumulator 130 to 0 for subsequent computation.

In the embodiment described above, it was described that the single unit PE 10 performs the computation. However, the present embodiment may be performed in a pipeline manner using multiple unit PEs 10a, 10b, 10c, and 10d.

In the embodiment illustrated in FIG. 1, the computing apparatus 1 includes the unit PEs 10a, 10b, 10c, and 10d. The unit PE 10a performs the first phase, the unit PE 10b performs the second phase, the unit PE 10c performs the third phase, and the unit PE 10d performs the fourth phase, so that the computation may be performed in a pipeline manner.

In this embodiment, the accumulator included in the unit PE performing the first phase may perform the pipelined computation by providing the accumulated value to the multiplier included in the unit PE performing the second phase.

According to the present embodiment, the computing apparatus that performs the multiply and accumulate (MAC) can perform the non-linear activation function acceleration computation, thereby increasing the area efficiency.

Although the present invention has been described with reference to the embodiments illustrated in the drawings to help understanding thereof, these are merely exemplary embodiments for implementation, and those skilled in the art will understand that various modifications and equivalent other embodiments are possible therefrom. Accordingly, the true technical scope of the present invention is to be determined by the spirit of the appended claims.

What is claimed is:

1. A computing apparatus for computing an interpolated non-linear activation function for an input, comprising:
a plurality of unit processing elements (PEs),
wherein each of the unit PEs includes:
a multiplier that multiplies the input and an output of an accumulator;
an adder that adds the output of the multiplier and a coefficient of the interpolated non-linear activation function; and
an accumulator that accumulates and outputs the output of the adder.

2. The computing apparatus of claim 1, wherein, after the computation is completed, the output of the accumulator corresponds to a result of calculating the interpolated non-linear activation function for the input.

3. The computing apparatus of claim 1, wherein each of the unit PEs further includes:
a coefficient memory that stores the coefficient of the interpolated non-linear activation function; and
a pre-processor that controls the coefficient memory to output the coefficient stored in the coefficient memory.

4. The computing apparatus of claim 1, wherein each of the unit PEs further includes:
a post-processor that, when a final computation result of the interpolated non-linear activation function for the input is accumulated in the accumulator, controls the computation result from the accumulator to be output to the outside.

5. The computing apparatus of claim 1, wherein the non-linear activation function is one of a rectified linear unit (ReLU) function, a Gaussian error linear unit (GeLu), and a sigmoid function.

6. The computing apparatus of claim 1, wherein the interpolated non-linear activation function is a non-linear activation function interpolated with a quadratic function.

7. The computing apparatus of claim 1, wherein the computing apparatus sequentially performs a plurality of operations, and
a first operation among the plurality of operations is performed by
multiplying, by the multiplier, an output of an initialized accumulator and the input, and
outputting a result of adding, by the adder, the multiplied result and a coefficient of a highest order term of the non-linear activation function to the accumulator.

8. The computing apparatus of claim 7, wherein an operation after the first operation among the plurality of operations is performed by storing, by the accumulator, the added result from the adder and outputting the stored added result to the multiplier,
multiplying, by the multiplier, an output of the accumulator and the input, and
outputting a result of adding, by the adder, the multiplied result and the coefficient of the non-linear activation function to the accumulator.

9. The computing apparatus of claim 7, wherein a last operation among the plurality of operations is performed by storing, by the accumulator, the added result from the adder and outputting the stored added result to the post-processor, and
outputting, by the post-processor, the computation result from the accumulator.

10. The computing apparatus of claim 7, wherein the computing apparatus performs a pipeline computation with the plurality of unit PEs to perform the plurality of operations on the pipeline computation sequentially.

11. A computing method of computing an interpolated non-linear activation function for an input with a computing apparatus including a plurality of unit processing elements (PEs), wherein the computing method includes a plurality of phases performed sequentially, each of which includes:
an operation of multiplying, by a multiplier, an output of an accumulator and the input; and
an operation of outputting a result of adding, by an adder, the multiplied result from the multiplier and a coefficient of the non-linear activation function to the accumulator.

12. The computing method of claim 11, wherein a first phase includes:
an operation of multiplying, by the multiplier, an output of an initialized accumulator and the input; and
an operation of outputting a result of adding, by the adder, the multiplied result from the multiplier and the coefficient of the non-linear activation function to the accumulator.

13. The computing method of claim 11, wherein an operation after the first operation among the plurality of operations performed sequentially is performed by storing and outputting, by the accumulator, the added result from the adder,
multiplying, by the multiplier, the output of the accumulator and the input, and
outputting a result of adding, by the adder, the multiplied result and the coefficient of the non-linear activation function to the accumulator.

14. The computing method of claim 11, wherein a last operation among the plurality of operations is performed by storing, by the accumulator, the added result from the adder and outputting the stored added result to the post-processor, and
outputting, by the post processor, the computation result from the accumulator.

15. The computing method of claim 11, wherein the plurality of sequentially performed operations are performed in a pipeline manner in the plurality of unit PEs.

16. The computing method of claim 11, wherein the interpolated non-linear activation function is a non-linear activation function interpolated with a quadratic function.
